(19) United States
(12) Patent Application Publication
(10) Pub. No.: US 2017/0194793 A1
(43) Pub. Date: Jul. 6, 2017

(54) GRID-CONNECTED CONTROL METHOD BASED ON VIRTUAL SYNCHRONIZER AND DEVICE THEREOF

(71) Applicant: Sungrow Power Supply Co., Ltd., Hefei (CN)

(72) Inventors: Tao JIANG, Hefei (CN); Yong YU, Hefei (CN); Kaihuan ZHANG, Hefei (CN)

(21) Appl. No.: 15/194,919

(22) Filed: Jun. 28, 2016

(30) Foreign Application Priority Data
Dec. 30, 2015 (CN) 201511029011.3

(51) Int. Cl. H02J 3/42; H02J 7/00

(52) U.S. Cl. CPC H02J 3/42; H02J 7/0068

(57) ABSTRACT

A grid-connected control method based on a virtual synchronizer is provided. The method includes: detecting whether a first deviation between an output voltage of an inverter and a voltage of a grid exceeds a first set voltage threshold, and adjusting a set output voltage of the inverter if the first deviation exceeds the first set voltage threshold, so that the first deviation falls within the first set voltage threshold; detecting whether a second deviation between an output frequency of the inverter and a frequency of the grid exceeds a first set frequency threshold, and adjusting a set output frequency of the inverter if the second deviation exceeds the first set frequency threshold, so that the second deviation falls within the first set frequency threshold; and controlling the inverter to connect to the grid. A grid-connected control device based on a virtual synchronizer is further provided.

### CROSS REFERENCE OF RELATED APPLICATION

This application claims the priority to Chinese Patent Application No. 201511029011.3, entitled “GRID-CONNECTED CONTROL METHOD BASED ON VIRTUAL SYNCHRONIZER AND DEVICE THEREOF”, filed with the Chinese State Intellectual Property Office on Dec. 30, 2015, which is incorporated by reference in its entirety herein.

### FIELD

The present disclosure relates to the field of inverter control technology, and particularly to a grid-connected control method based on a virtual synchronizer and a device thereof.

### BACKGROUND

Control on a virtual synchronizer has an advantage of droop control, and can realize droop adjustment control between a frequency and an active power and between a voltage and a reactive power. Also, the virtual synchronizer, which has an inertial component, can perform smooth adjustment on the frequency. An energy-storage inverter based on control of the virtual synchronizer has been widely adopted in an actual application.

Before the energy-storage inverter based on the control of the virtual synchronizer performs grid-connected operation, it is determined whether an alternating-current voltage outputted from the energy-storage inverter is synchronous with a voltage of an external grid. Only in a case of a positive determination, the energy-storage inverter can be connected to the grid with reduced impact to the grid in a grid-connected process.

Therefore, it is desired to provide a grid-connected control method for the energy-storage inverter, for successfully and smoothly connecting the energy-storage inverter to the grid without any impact to the grid.

### SUMMARY

In order to solve the technical problem in the conventional technology, a grid-connected control method based on a virtual synchronizer and a device thereof are provided according to the present disclosure, for successfully and smoothly connecting an energy-storage inverter to the grid without any impact to the grid.

A grid-connected control method based on a virtual synchronizer is provided according to an embodiment of the present disclosure. The grid-connected control method includes:

detecting whether a first deviation between an output voltage of an inverter and a voltage of a grid exceeds a first set voltage threshold, and adjusting a set output voltage of the inverter in a case that it is detected that the first deviation exceeds the first set voltage threshold, so that the first deviation falls within the first set voltage threshold;

detecting whether a second deviation between an output frequency of the inverter and a frequency of the grid exceeds a first set frequency threshold, and adjusting a set output frequency of the inverter in a case that it is detected that the second deviation exceeds the first set frequency threshold, so that the second deviation falls within the first set frequency threshold; and

controlling the inverter to connect to the grid when a phase of a voltage of the grid is consistent with a phase of an output voltage of the inverter in a case that the first deviation falls within the first set voltage threshold and the second deviation falls within the first set frequency threshold.

Preferably, the adjusting the set output voltage of the inverter in a case that it is detected that the first deviation exceeds the first set voltage threshold may include:

decreasing the set output voltage of the inverter with a preset first step size in a case that the output voltage of the inverter is greater than the voltage of the grid; or

increasing the set output voltage of the inverter with a preset second step size in a case that the output voltage of the inverter is less than the voltage of the grid.

Preferably, the adjusting the set output frequency of the inverter in a case that it is detected that the second deviation exceeds the first set frequency threshold may include:

decreasing the set output frequency of the inverter with a preset third step size in a case that the output frequency of the inverter is greater than the frequency of the grid; or

increasing the set output frequency of the inverter with a preset fourth step size in a case that the output frequency of the inverter is less than the frequency of the grid.

Preferably, after the inverter is connected to the grid successfully, the grid-connected control method may further include:

increasing the set output voltage of the inverter with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold, and setting the set output voltage of the inverter to be the voltage of the grid; or

decreasing the set output voltage of the inverter with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold, and setting the set output voltage of the inverter to be the voltage of the grid.

Preferably, after the inverter is connected to the grid successfully, the grid-connected control method may further include:

increasing the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and setting the set output frequency of the inverter to be the frequency of the grid; or

decreasing the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and setting the set output frequency of the inverter to be the frequency of the grid.

A grid-connected control device based on a virtual synchronizer is further provided according to an embodiment of the present disclosure. The grid-connected control device includes a first deviation determination unit, a set output voltage adjustment unit, a second deviation determination unit, a set output frequency adjustment unit and a control unit.

The first deviation determination unit may be configured to detect whether a first deviation between an output voltage of the inverter and a voltage of a grid exceeds a first set voltage threshold.

The set output voltage adjustment unit is configured to adjust the set output voltage of an inverter in a case that the first deviation exceeds the first set voltage threshold, so that the first deviation falls within the first set voltage threshold.

The second deviation determination unit may be configured to determine whether a second deviation between an output frequency of the inverter and a frequency of a grid exceeds a first set frequency threshold.

The set output frequency adjustment unit is configured to adjust a set output frequency of the inverter in a case that the second deviation exceeds the first set frequency threshold, so that the second deviation falls within the first set frequency threshold.

The control unit may be configured to control the inverter to connect to the grid when a phase of a voltage of the grid is consistent with a phase of an output voltage of the inverter in a case that the first deviation falls within the first set voltage threshold and the second deviation falls within the first set frequency threshold.

Preferably, the first deviation determination unit may include a first deviation determination subunit. The set output voltage adjustment unit may include a set output voltage decrease adjustment subunit and a set output voltage increase adjustment subunit.

The first deviation determination subunit may be configured to determine whether the output voltage of the inverter is greater than the voltage of the grid in a case that the first deviation between the output voltage of the inverter and the voltage of the grid exceeds the first set voltage threshold.

The set output voltage decrease adjustment subunit may be configured to decrease the set output voltage of the inverter with a preset first step size in a case that the output voltage of the inverter is greater than the voltage of the grid.

The set output voltage increase adjustment subunit may be configured to increase the set output voltage of the inverter with a preset second step size in a case that the output voltage of the inverter is less than the voltage of the grid.

Preferably, the second deviation determination unit may include a second deviation determination subunit. The set output frequency adjustment unit may include a set output frequency decrease adjustment subunit and a set output frequency increase adjustment subunit.

The second deviation determination subunit may be configured to determine whether the output frequency of the inverter is greater than the frequency of the grid in a case that the second deviation between the output frequency of the inverter and the frequency of the grid exceeds the first set frequency threshold.

The set output frequency decrease adjustment subunit may be configured to decrease the set output frequency of the inverter with a preset third step size in a case that the output frequency of the inverter is greater than the frequency of the grid.

The set output frequency increase adjustment subunit may be configured to increase the set output frequency of the inverter with a preset fourth step size in a case that the output frequency of the inverter is less than the frequency of the grid.

Preferably, the grid-connected control device may further include a voltage recovery increase unit and a voltage recovery decrease unit.

The voltage recovery increase unit may be configured to increase the set output voltage with a fifth step size after the inverter is connected to the grid successfully in a case that the set output voltage is decreased with the preset first step size before the inverter is connected to the grid, until a third deviation between the set output voltage of the inverter and the voltage of the grid falls within a second set voltage threshold, and set the set output voltage of the inverter to be the voltage of the grid.

The voltage recovery decrease unit may be configured to decrease the set output voltage with a sixth step size after the inverter is connected to the grid successfully in a case that the set output voltage is increased with the preset second step size before the inverter is connected to the grid, until a third deviation between the set output voltage of the inverter and the voltage of the grid falls within a second set voltage threshold, and set the set output voltage of the inverter to be the voltage of the grid.

Preferably, the grid-connected control device may further include a frequency recovery increase unit and a frequency recovery decrease unit.

The frequency recovery increase unit may be configured to increase the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and setting the set output frequency of the inverter to be the frequency of the grid.

The frequency recovery decrease unit may be configured to decrease the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and setting the set output frequency of the inverter to be the frequency of the grid.

Compared with the conventional technology, the present has at least following advantages.

The output voltage of the inverter is detected. It is considered that the voltage of the inverter is synchronous with the voltage of the grid only in a case that the first deviation between the output voltage of the inverter and the voltage of the grid falls within the first set voltage threshold; or else the output voltage of the inverter is adjusted by adjusting the set output voltage of the inverter. The output frequency of the inverter is detected. It is considered that the frequency of the inverter is synchronous with the frequency of the grid only in a case that the second deviation between the output frequency of the inverter and the frequency of the grid falls within the first set frequency threshold; or else the output frequency of the inverter is adjusted by adjusting the set output frequency of the inverter. Only in a case that the voltage and the frequency of the inverter are synchronous with the voltage and the frequency of the grid respectively, the inverter can be controlled to connect to the grid. In a case that either the voltage or the frequency of the inverter is asynchronous with the voltage or the frequency of the grid, impact is caused to the grid in a grid-connected process. In the grid-connected control method according to the embodiment, the inverter can be connected to the grid successfully without any impact to the grid. Further, after the grid is recovered and is connected to a micro gird for an energy-storage inverter, the grid-connected control method can ensure that a load power can be transferred to the external grid smoothly without any power impact to the external grid and the micro grid.

### BRIEF DESCRIPTION OF THE DRAWINGS

The drawings to be used in the description of the embodiments of the disclosure or the conventional technology will be described briefly as follows, so that the technical solutions according to the embodiments of the present disclosure or according to the conventional technology will become clearer. It is apparent that the drawings in the following description only illustrate some embodiments of the present application. For those skilled in the art, other drawings may be obtained according to these drawings without any creative work.

FIG. 1 is a schematic diagram of an application scenario of an energy-storage inverter according to the present disclosure;

FIG. 2 is a flow diagram of a first method embodiment of a grid-connected control method according to the present disclosure;

FIG. 3 is a flow diagram of a second method embodiment of a grid-connected control method according to the present disclosure;

FIG. 4 is a flow diagram of a third method embodiment of a grid-connected control method according to the present disclosure;

FIG. 5 is a schematic diagram of a first device embodiment of a grid-connected control device according to the present disclosure;

FIG. 6 is a schematic diagram of a second device embodiment of a grid-connected control device according to the present disclosure; and

FIG. 7 is a schematic diagram of a third device embodiment of a grid-connected control device according to the present disclosure.

### DETAILED DESCRIPTION OF THE EMBODIMENTS

In order to make the skilled in the art understand the technical solution of the present disclosure better, the technical solution according to the embodiments of the present disclosure are described clearly and completely below in conjunction with the drawings in the embodiments of the present disclosure. It is apparent that the described embodiments are only a part rather than all of the embodiments. All other embodiments obtained by those skilled in the art without creative work based on the embodiments of the present disclosure will fall within the protection scope of the present disclosure.

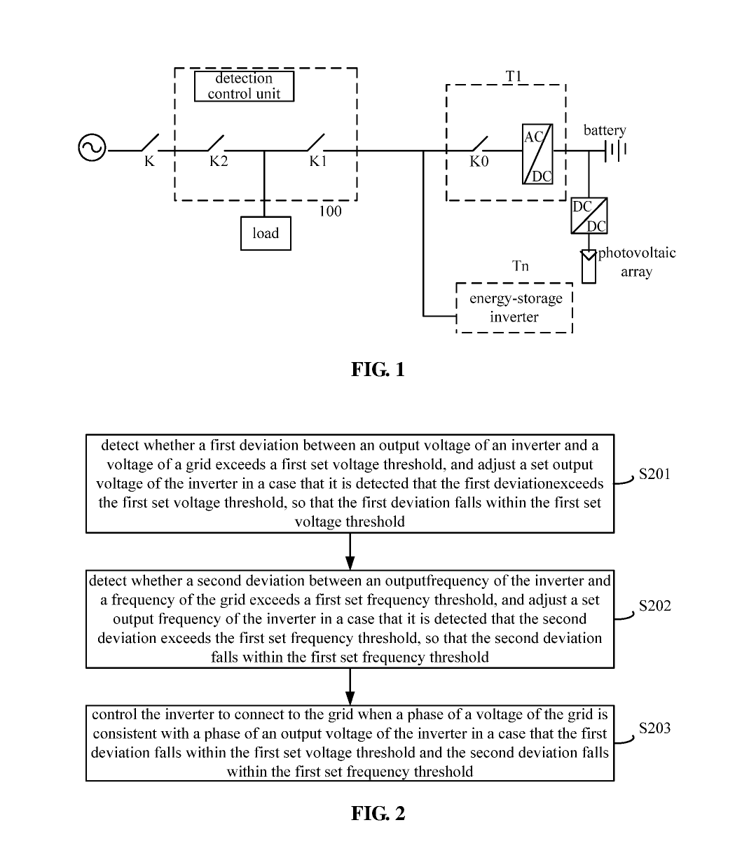

An application scenario of an energy-storage inverter is introduced first, so that the technology according to the present disclosure is understood better by those skilled in the art. Reference is made to FIG. 1, which is a schematic diagram of an application scenario of the energy-storage inverter according to the present disclosure.

It is to be noted that, an inverter in the present disclosure refers to the energy-storage inverter, and is abbreviated as an inverter hereinafter. It can be understood that, there may be one energy-storage inverter, or multiple energy-storage inverters connected together. As shown in FIG. 1, there are two energy-storage inverters T1 and Tn. All the energy-storage inverters have a same structure.

K is an access switch for an external grid.

K1 is a synchronous switch at a micro-grid side in an intelligent coordination control cabinet.

K2 is a synchronous switch at an external-grid side in the intelligent coordination control cabinet.

K0 is an alternating-current output contactor of the energy-storage inverter.

A detection control unit in the intelligent coordination control cabinet 100 is configured to communicate with each of the energy-storage inverters, and perform synchronous logic determination in a connection process of the external grid to the micro grid, and control K2 to be turned on after the external grid becomes synchronous with the micro grid.

The inverter is configured to perform synchronous logic determination in a connection process of the micro grid to the external grid, and turn on the alternating-current output contactor thereof after the external grid becomes synchronous with the micro grid.

A direct-current side of the inverter is connected with a battery. The battery is charged by a photovoltaic array via DC-DC. The photovoltaic array also provides a direct current for the direct-current side of the inverter.

It can be understood that, DC-DC is a way of charging, by the energy-storage inverter, an accumulator when the accumulator is lack of electricity, which is not limited thereto.

The grid-connected control method according to the present disclosure is applied to synchronize a voltage and a frequency of the energy-storage inverter with a voltage and a frequency of the grid, for successfully connecting the energy-storage inverter to the grid.

### First Method Embodiment

Reference is made to FIG. 2, which is a flow diagram of a first method embodiment of a grid-connected control method according to the present disclosure.

It can be understood that, since that synchronous between the energy-storage inverter and the grid not only includes voltage synchronization but also includes frequency synchronization, determination is made in terms of both a voltage and a frequency. The voltage represents an amplitude of the voltage, and the frequency represents a phase of the voltage. That is, the inverter can be connected to the grid only in a case that an amplitude and a phase of the voltage of the inverter are synchronous with an amplitude and a phase of a voltage of the grid respectively. In the present disclosure, the energy-storage inverter, which has a characteristic of droop control of the virtual synchronizer, can realize droop control between a frequency and an active power and between a voltage and an inactive power.

The grid-connected control method based on a virtual synchronizer according to the embodiment includes steps S201 to S203.

In step S201, it is detected whether a first deviation between an output voltage of an inverter and a voltage of a grid exceeds a first set voltage threshold, and a set output voltage of the inverter is adjusted in a case that it is detected that the first deviation exceeds the first set voltage threshold, so that the first deviation falls within the first set voltage threshold.

It can be understood that, the first set voltage threshold is set as required, which is not defined in the present disclosure. In a case that the first deviation between the output voltage of the inverter and the voltage of the grid falls within the first set voltage threshold, it is considered that the first deviation falls within an allowable range, that is, the voltage of the inverter is synchronous with the voltage of the grid.

In step S202, it is detected whether a second deviation between an output frequency of the inverter and a frequency of the grid exceeds a first set frequency threshold, and a set output frequency of the inverter is adjusted in a case that it is detected that the second deviation exceeds the first set frequency threshold, so that the second deviation falls within the first set frequency threshold.

It can be understood that, the first set frequency threshold is set as required, which is not defined in the present disclosure. In a case that the second deviation between the output frequency of the inverter and the frequency of the grid falls within the first set frequency threshold, it is considered that the second deviation falls within an allowable range, that is, the frequency of the inverter is synchronous with the frequency of the grid.

In step S203, the inverter is controlled to connect to the grid when a phase of a voltage of the grid is consistent with a phase of an output voltage of the inverter in a case that the first deviation falls within the first set voltage threshold and the second deviation falls within the first set frequency threshold.

It can be understood that, the phase of the voltage of the grid being consistent with the phase of the output voltage of the inverter refers to that a phase difference between the phase of the voltage of the grid and the phase of the output voltage of the inverter falls within a preset phase range.

Only in a case that the voltage and the frequency of the inverter are synchronous with the voltage and the frequency of the grid respectively, the inverter can be controlled to connect to the grid.

In the grid-connected control method according to the present disclosure, the output voltage of the inverter is detected. It is considered that the voltage of the inverter is synchronous with the voltage of the grid only in a case that the first deviation between the output voltage of the inverter and the voltage of the grid falls within the first set voltage threshold; or else the output voltage of the inverter is adjusted by adjusting the set output voltage of the inverter. The output frequency of the inverter is detected. It is considered that the frequency of the inverter is synchronous with the frequency of the grid only in a case that the second deviation between the output frequency of the inverter and the frequency of the grid falls within the first set frequency threshold; or else the output frequency of the inverter is adjusted by adjusting the set output frequency of the inverter. Only in a case that the voltage and the frequency of the inverter are synchronous with the voltage and the frequency of the grid respectively, the inverter can be controlled to connect to the grid. In a case that either the voltage or the frequency of the inverter is asynchronous with the voltage or the frequency of the grid, impact is caused to the grid in a grid-connected process. In the grid-connected control method according to the embodiment, the inverter can be connected to the grid successfully without any impact to the grid. Further, after the grid is recovered and is connected to a micro gird for an energy-storage inverter, the grid-connected control method can ensure that a load power can be transferred to the external grid smoothly without any power impact to the external grid and the micro grid.

### Second Method Embodiment

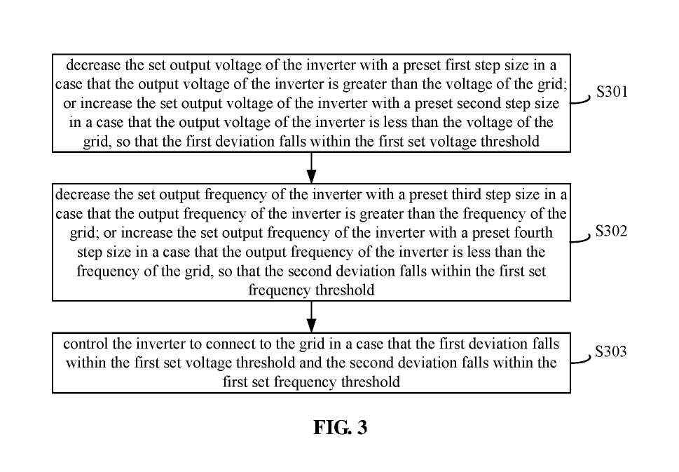

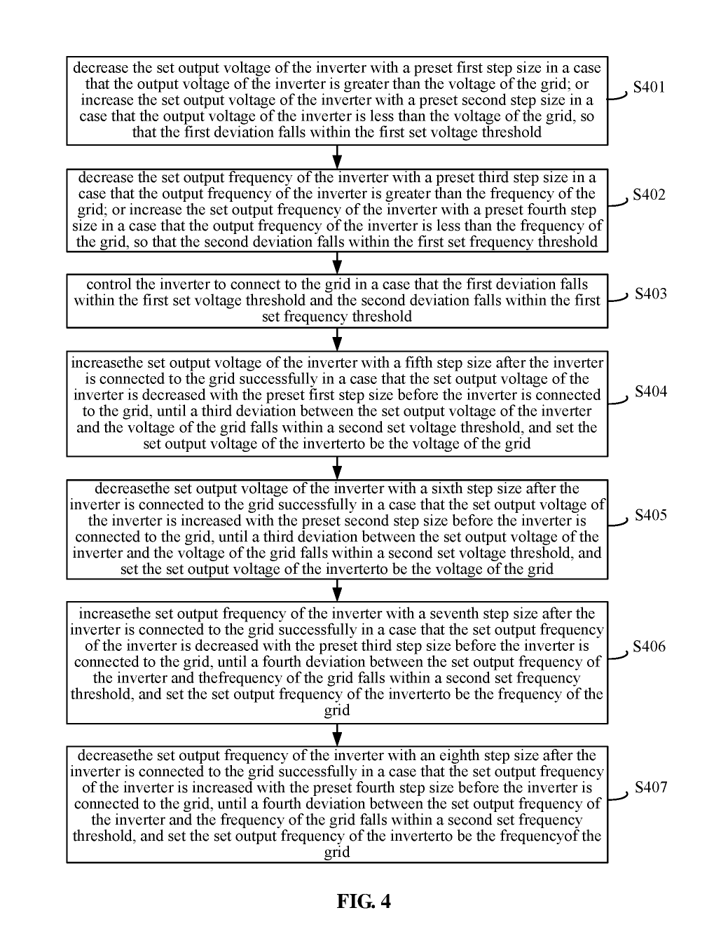

Reference is made to FIG. 3, which is a flow diagram of a second method embodiment of a grid-connected control method according to the present disclosure.

The grid-connected control method based on a virtual synchronizer according to the embodiment includes steps S301 to S303.

Specifically, the adjusting the set output voltage of the inverter in a case that it is detected that the first deviation exceeds the first set voltage threshold includes step S301.

In step S301, the set output voltage of the inverter is decreased with a preset first step size in a case that the output voltage of the inverter is greater than the voltage of the grid, or the set output voltage of the inverter is increased with a preset second step size in a case that the output voltage of the inverter is less than the voltage of the grid, so that the first deviation falls within the first set voltage threshold.

It can be understood that, the first deviation may be an absolute value of a difference between the output voltage of the inverter and the voltage of the grid. When the first deviation exceeds the first set voltage threshold, it means that the output voltage of the inverter is greater than the voltage of the grid, or the output voltage of the inverter is less than the voltage of the grid.

It is to be noted that the first step size may or may not be equal to the second step size.

The adjusting the set output frequency of the inverter in a case that it is detected that the second deviation exceeds the first set frequency threshold includes step S302.

In step S302, the set output frequency of the inverter is decreased with a preset third step size in a case that the output frequency of the inverter is greater than the frequency of the grid, or the set output frequency of the inverter is increased with a preset fourth step size in a case that the output frequency of the inverter is less than the frequency of the grid, so that the second deviation falls within the first set frequency threshold.

It can be understood that, the second deviation may be an absolute value of a difference between the output frequency of the inverter and the frequency of the grid. When the second deviation exceeds the first set frequency threshold, it means that the output frequency of the inverter is greater than the frequency of the grid, or the output frequency of the inverter is less than the frequency of the grid.

It is to be noted that the third step size may or may not be equal to the fourth step size.

In step S303, the inverter is controlled to connect to the grid when a phase of a voltage of the grid is consistent with a phase of an output voltage of the inverter in a case that the first deviation falls within the first set voltage threshold and the second deviation falls within the first set frequency threshold.

In the embodiment, in a case that the first deviation exceeds the first set voltage threshold, the output voltage of the inverter is synchronized with the voltage of the grid by adjusting the set output voltage of the inverter; and in a case that the second deviation exceeds the first set frequency threshold, the output frequency of the inverter is synchronized with a frequency of the grid by adjusting the set output frequency of the inverter, to prepare the inverter to successfully connect to the grid.

It can be understood that, the control process in the first method embodiment and the control process in the second method embodiment are performed before the inverter is connected to the grid, and the set output voltage and the set output frequency of the inverter are recovered after the inverter is connected to the grid successfully, which is described in detail below in conjunction with a third method embodiment.

### Third Method Embodiment

Reference is made to FIG. 4, which is a flow diagram of a third method embodiment of a grid-connected control method according to the present disclosure.

In the embodiment, steps S401 to S403 are the same as steps S301 to S303, respectively, which are not described here.

After the inverter is connected to the grid successfully, the grid-connected control method further includes following steps S404 to S407.

In step S404, the set output voltage of the inverter is increased with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold; and the set output voltage of the inverter is set to be the voltage of the grid.

A load reactive power bore by the inverter will be transferred to the external grid gradually in a process of gradually increasing the set output voltage of the inverter.

It is to be noted that the first step size may or may not be equal to the fifth step size.

In step S405, the set output voltage of the inverter is decreased with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold; and the set output voltage of the inverter is set to be the voltage of the grid.

The load reactive power bore by the inverter will be transferred to the external grid gradually in a process of gradually decreasing the set output voltage of the inverter.

It is to be noted that the second step size may or may not be equal to the sixth step size

It is to be noted that there is no sequential order between the steps S404 and S405.

It can be understood that, a reactive power outputted from the inverter will reach a set value in a case that the set output voltage of the inverter is set to be the voltage of the grid.

In step S406, the set output frequency of the inverter is increased with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold; and the set output frequency of the inverter is set to be the frequency of the grid.

A load active power bore by the inverter is transferred to the external grid gradually in a process of gradually increasing the set output frequency of the inverter.

It is to be noted that the third step size may or may not be equal to the seventh step size.

In step S407, the set output frequency of the inverter is decreased with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold; and the set output frequency of the inverter is set to be the frequency of the grid.

The load active power bore by the inverter is transferred to the external grid gradually in a process of gradually decreasing the set output frequency of the inverter.

It is to be noted that the fourth step size may or may not be equal to the eighth step size.

It is to be noted that there is no sequential order between steps S406 and S407.

It can be understood that, after being recovered, the set output voltage and the set output frequency of the inverter will not be changed again until the inverter is started for a next time.

In the grid-connected control method according to the embodiment, the set output voltage and the set output frequency of the inverter may be recovered automatically after the inverter is connected to the grid successfully. It can be understood that, an object of recovering the set output voltage and the set output frequency of the inverter is smoothly transferring a load power bore by the inverter to the external grid, so that the inverter charges the battery as possible. Or else, the battery will continue to be lack of electricity.

With the grid-connected control method embodiments according to the present disclosure described above, smooth grid-connected control can be ensured effectively in any parameter setting range, and it is effectively avoided a complicated process of resetting an operating parameter by the inverter every time before the inverter performs grid-connected operation. Also, the grid-connected control method does not affect regulating performance of the energy-storage inverter in performing the off-grid operation. Parameter regulating such as power scheduling can be performed normally in the off-grid process, and the inverter can be connected to the grid successfully through the grid-connected voltage and frequency adjustment process as required.

Based on the grid-connected control method based on the virtual synchronizer according to the above embodiments, the embodiment of the present disclosure further provides a grid-connected control device based on a virtual synchronizer, which is described in detail below in conjunction with drawings.

### First Device Embodiment

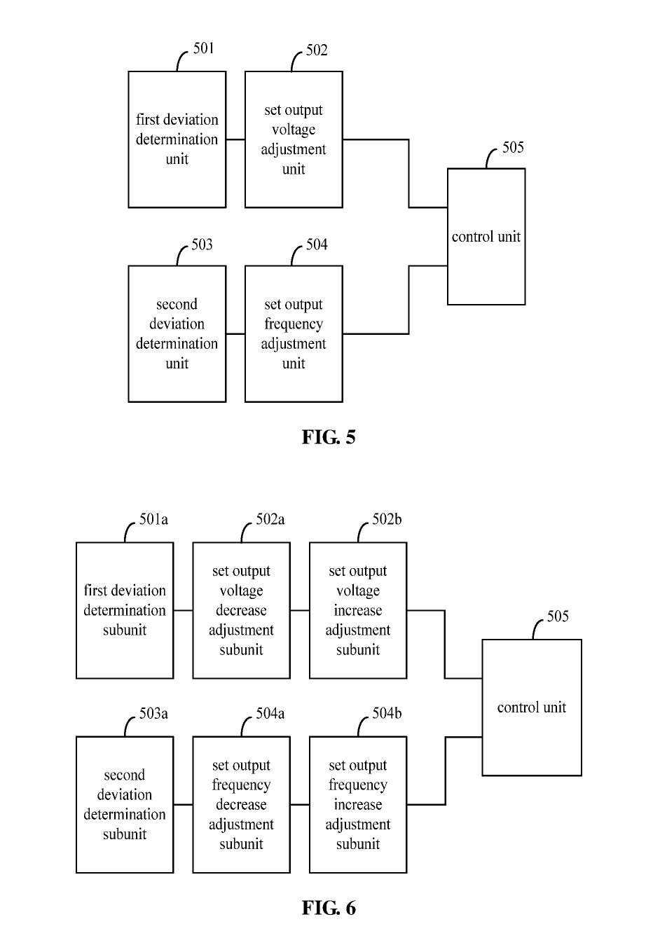

Reference is made to FIG. 5, which is a schematic diagram of a first device embodiment of a grid-connected control device according to the present disclosure.

It can be understood that, since that synchronous between the energy-storage inverter and the grid not only includes voltage synchronization but also includes frequency synchronization, determination is made in terms of both a voltage and a frequency. The voltage represents an amplitude of the voltage, and the frequency represents a phase of the voltage. That is, the inverter can be connected to the grid only in a case that an amplitude and a phase of the voltage of the inverter are synchronous with an amplitude and a phase of a voltage of the grid respectively. In the present disclosure, the energy-storage inverter, which has a characteristic of droop control of the virtual synchronizer, can realize droop control between a frequency and an active power and between a voltage and an inactive power.

The grid-connected control device based on the virtual synchronizer according to the embodiment includes a first deviation determination unit 501, a set output voltage adjustment unit 502, a second deviation determination unit 503, a set output frequency adjustment unit 504 and a control unit 505.

The first deviation determination unit 501 is configured to detect whether a first deviation between an output voltage of an inverter and a voltage of a grid exceeds a first set voltage threshold.

It can be understood that, the first set voltage threshold is set as required, which is not defined in the present disclosure. In a case that the first deviation between the output voltage of the inverter and the voltage of the grid falls within the first set voltage threshold, it is considered that the first deviation falls within an allowable range, that is, the voltage of the inverter is synchronous with the voltage of the grid.

The set output voltage adjustment unit 502 is configured to adjust a set output voltage of the inverter in a case that it is detected that the first deviation exceeds the first set voltage threshold, so that the first deviation falls within the first set voltage threshold.

The second deviation determination unit 503 is configured to detect whether the second deviation between the output frequency of the inverter and the frequency of the grid exceeds the first set frequency threshold.

It can be understood that, a first set frequency threshold is set as required, which is not defined in the present disclosure. In a case that the second deviation between the output frequency of the inverter and the frequency of the grid falls within the first set frequency threshold, it is considered that the second deviation falls within an allowable range, that is, the frequency of the inverter is synchronous with the frequency of the grid.

The set output frequency adjustment unit 504 is configured to adjust a set output frequency of the inverter is adjusted in a case that it is detected that the second deviation exceeds the first set frequency threshold, so that the second deviation falls within the first set frequency threshold.

The control unit 505 is configured to control the inverter to connect to the grid when a phase of a voltage of the grid is consistent with a phase of an output voltage of the inverter in a case that the first deviation falls within the first set voltage threshold and the second deviation falls within the first set frequency threshold.

It can be understood that, the phase of the voltage of the grid being consistent with the phase of the output voltage of the inverter refers to that a phase difference between the phase of the voltage of the grid and the phase of the output voltage of the inverter falls within a preset phase range.

Only in a case that the voltage and the frequency of the inverter are synchronous with the voltage and the frequency of the grid respectively, the inverter can be controlled to connect to the grid.

In the grid-connected control device according to the present disclosure, the output voltage of the inverter is detected. It is considered that the voltage of the inverter is synchronous with the voltage of the grid only in a case that the first deviation between the output voltage of the inverter and the voltage of the grid falls within the first set voltage threshold; or else the output voltage of the inverter is adjusted by adjusting the set output voltage of the inverter. The output frequency of the inverter is detected. It is considered that the frequency of the inverter is synchronous with the frequency of the grid only in a case that the second deviation between the output frequency of the inverter and the frequency of the grid falls within the first set frequency threshold; or else the output frequency of the inverter is adjusted by adjusting the set output frequency of the inverter. Only in a case that the voltage and the frequency of the inverter are synchronous with the voltage and the frequency of the grid respectively, the inverter can be controlled to connect to the grid when it is determined that the phase difference between the phase of the voltage of the grid and the phase of the output voltage of the inverter meets the requirement. In a case that either the voltage or the frequency of the inverter is asynchronous with the voltage or the frequency of the grid, impact is caused to the grid in a grid-connected process. In the grid-connected control device according to the embodiment, the inverter can be connected to the grid successfully without any impact to the grid. Further, after the grid is recovered and is connected to a micro gird for an energy-storage inverter, the grid-connected control device can ensure that a load power can be transferred to the external grid smoothly without any power impact to the external grid and the micro grid.

### Second Device Embodiment

Reference is made to FIG. 6, which is a schematic diagram of a second device embodiment of a grid-connected control device according to the present disclosure.

The first deviation determination unit 501 includes a first deviation determination subunit 501a. The set output voltage adjustment unit 502 includes a set output voltage decrease adjustment subunit 502a and a set output voltage increase adjustment subunit 502b.

The first deviation determination subunit 501a is configured to determine whether the output voltage of the inverter is greater than the voltage of the grid in a case that the first deviation between the output voltage of the inverter and the voltage of the grid exceeds the first set voltage threshold.

The set output voltage decrease adjustment subunit 502a is configured to decrease the set output voltage of the inverter with a preset first step size in a case that the output voltage of the inverter is greater than the voltage of the grid.

The set output voltage increase adjustment subunit 502b is configured to increase the set output voltage of the inverter with a preset second step size in a case that the output voltage of the inverter is less than the voltage of the grid.

It can be understood that, the first deviation may be an absolute value of a difference between the output voltage of the inverter and the voltage of the grid. When the first deviation exceeds the first set voltage threshold, it means that the output voltage of the inverter is greater than the voltage of the grid, or the output voltage of the inverter is less than the voltage of the grid.

It is to be noted that the first step size may or may not be equal to the second step size.

The second deviation determination unit 503 includes a second deviation determination subunit 503a. The set output frequency adjustment unit 504 includes a set output frequency decrease adjustment subunit 504a and a set output frequency increase adjustment subunit 504b.

The second deviation determination subunit 503a is configured to determine whether the output frequency of the inverter is greater than the frequency of the grid in a case that the second deviation between the output frequency of the inverter and the frequency of the grid exceeds the first set frequency threshold.

The set output frequency decrease adjustment subunit 504a is configured to decrease the set output frequency of the inverter with a preset third step size in a case that the output frequency of the inverter is greater than the frequency of the grid.

The set output frequency increase adjustment subunit 504b is configured to increase the set output frequency of the inverter with a preset fourth step size in a case that the output frequency of the inverter is less than the frequency of the grid.

It can be understood that, the second deviation may be an absolute value of a difference between the output frequency of the inverter and the frequency of the grid. When the second deviation exceeds the first set frequency threshold, it means that the output frequency of the inverter is greater than the frequency of the grid, or the output frequency of the inverter is less than the frequency of the grid.

It is to be noted that the third step size may or may not be equal to the fourth step size.

In the embodiment, in a case that the first deviation exceeds the first set voltage threshold, an output voltage of the inverter is synchronized with a voltage of the grid by adjusting the set output voltage of the inverter; and in a case that the second deviation exceeds the first set frequency threshold, the output frequency of the inverter is synchronized with a frequency of the grid by adjusting the set output frequency of the inverter, to prepare the inverter to successfully connect to the grid.

### Third Device Embodiment

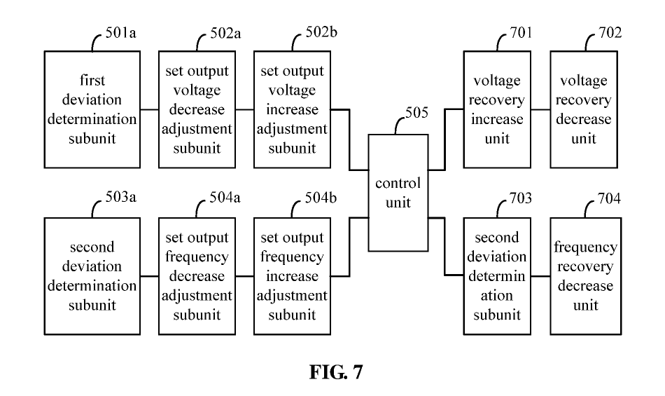

Reference is made to FIG. 7, which is a schematic diagram of a third device embodiment of a grid-connected control device according to the present disclosure.

The grid-connected control device according to the embodiment further includes a voltage recovery increase unit 701 and a voltage recovery decrease unit 702.

The voltage recovery increase unit 701 is configured to increase the set output voltage of the inverter with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold, and set the set output voltage of the inverter to be the voltage of the grid.

A load reactive power bore by the inverter will be transferred to the external grid gradually in a process of gradually increasing the set output voltage of the inverter.

It is to be noted that the first step size may or may not be equal to the fifth step size.

The voltage recovery decrease unit 702 is configured to decrease the set output voltage of the inverter with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold, and set the set output voltage of the inverter to be the voltage of the grid.

The load reactive power bore by the inverter will be transferred to the external grid gradually in a process of gradually decreasing the set output voltage of the inverter.

It is to be noted that the second step size may or may not be equal to the sixth step size.

The grid-connected control device according to the embodiment further includes a frequency recovery increase unit 703 and a frequency recovery decrease unit 704.

The frequency recovery increase unit 703 is configured to increase the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and set the set output frequency of the inverter to be the frequency of the grid.

A load active power bore by the inverter is transferred to the external grid gradually in a process of gradually increasing the set output frequency of the inverter.

It is to be noted that the third step size may or may not be equal to the seventh step size.

The frequency recovery decrease unit 704 is configured to decrease the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and set the set output frequency of the inverter to be the frequency of the grid.

The load active power bore by the inverter is transferred to the external grid gradually in a process of gradually decreasing the set output frequency of the inverter.

It is to be noted that the fourth step size may or may not be equal to the eighth step size.

It can be understood that, after being recovered, the set output voltage and the set output frequency of the inverter will not be changed again until the inverter is started for a next time.

In the grid-connected control device according to the embodiment, the set output voltage and the set output frequency of the inverter may be recovered automatically after the inverter is connected to the grid successfully. It can be understood that, an object of recovering the set output voltage and the set output frequency of the inverter is smoothly transferring a load power bore by the inverter to the external grid, so that the inverter charges the battery as possible. Or else, the battery will continue to be lack of electricity.

With the grid-connected control device embodiments according to the present disclosure described above, smooth grid-connected control can be ensured effectively in any parameter setting range, and it is effectively avoided a complicated process of resetting an operating parameter by the inverter every time before the inverter performs grid-connected operation. Also, the grid-connected control device does not affect regulating performance of the energy-storage inverter in performing the off-grid operation. Parameter regulating such as power scheduling can be performed normally in the off-grid process, and the inverter can be connected to the grid successfully through the grid-connected voltage and frequency adjustment process as required.

What described above are only preferred embodiments of the present disclosure and is not intended to limit the present disclosure in any way. The preferred embodiments of the present disclosure are disclosed above, which should not be interpreted as limiting the present disclosure. Numerous alternations, modifications, and equivalents can be made to the technical solutions of the present disclosure by those skilled in the art in light of the methods and technical content disclosed herein without deviation from the scope of the present disclosure. Therefore, any alternations, modifications, and equivalents made to the embodiments above according to the technical essential of the present disclosure without deviation from the scope of the present disclosure should fall within the scope of protection of the present disclosure.

1. A grid-connected control method based on a virtual synchronizer, wherein the grid-connected control method comprises:
detecting whether a first deviation between an output voltage of an inverter and a voltage of a grid exceeds a first set voltage threshold, and adjusting a set output voltage of the inverter in a case that it is detected that the first deviation exceeds the first set voltage threshold, so that the first deviation falls within the first set voltage threshold;
detecting whether a second deviation between an output frequency of the inverter and a frequency of the grid exceeds a first set frequency threshold, and adjusting a set output frequency of the inverter in a case that it is detected that the second deviation exceeds the first set frequency threshold, so that the second deviation falls within the first set frequency threshold; and
controlling the inverter to connect to the grid when a phase of a voltage of the grid is consistent with a phase of an output voltage of the inverter in a case that the first deviation falls within the first set voltage threshold and the second deviation falls within the first set frequency threshold.

2. The grid-connected control method based on the virtual synchronizer according to claim 1, wherein the adjusting the set output voltage of the inverter in a case that it is detected that the first deviation exceeds the first set voltage threshold comprises:
decreasing the set output voltage of the inverter with a preset first step size in a case that the output voltage of the inverter is greater than the voltage of the grid; or
increasing the set output voltage of the inverter with a preset second step size in a case that the output voltage of the inverter is less than the voltage of the grid.

3. The grid-connected control method based on the virtual synchronizer according to claim 1, wherein the adjusting the set output frequency of the inverter in a case that it is detected that the second deviation exceeds the first set frequency threshold comprises:
decreasing the set output frequency of the inverter with a preset third step size in a case that the output frequency of the inverter is greater than the frequency of the grid; or
increasing the set output frequency of the inverter with a preset fourth step size in a case that the output frequency of the inverter is less than the frequency of the grid.

4. The grid-connected control method based on the virtual synchronizer according to claim 1, wherein after the inverter is connected to the grid successfully, the grid-connected control method further comprises:
increasing the set output voltage of the inverter with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold, and setting the set output voltage of the inverter to be the voltage of the grid; or
decreasing the set output voltage of the inverter with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold, and setting the set output voltage of the inverter to be the voltage of the grid.

5. The grid-connected control method based on the virtual synchronizer according to claim 2, wherein after the inverter is connected to the grid successfully, the grid-connected control method further comprises:
increasing the set output voltage of the inverter with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold, and setting the set output voltage of the inverter to be the voltage of the grid; or
decreasing the set output voltage of the inverter with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold, and setting the set output voltage of the inverter to be the voltage of the grid.

6. The grid-connected control method based on the virtual synchronizer according to claim 3, wherein after the inverter is connected to the grid successfully, the grid-connected control method further comprises:
increasing the set output voltage of the inverter with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold, and setting the set output voltage of the inverter to be the voltage of the grid; or
decreasing the set output voltage of the inverter with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold, and setting the set output voltage of the inverter to be the voltage of the grid.

7. The grid-connected control method based on the virtual synchronizer according to claim 1, wherein after the inverter is connected to the grid successfully, the grid-connected control method further comprises:
increasing the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and setting the set output frequency of the inverter to be the frequency of the grid; or
decreasing the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and setting the set output frequency of the inverter to be the frequency of the grid.

8. The grid-connected control method based on the virtual synchronizer according to claim 2, wherein after the inverter is connected to the grid successfully, the grid-connected control method further comprises:
increasing the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and setting the set output frequency of the inverter to be the frequency of the grid; or
decreasing the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and setting the set output frequency of the inverter to be the frequency of the grid.

9. The grid-connected control method based on the virtual synchronizer according to claim 3, wherein after the inverter is connected to the grid successfully, the grid-connected control method further comprises:
increasing the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and setting the set output frequency of the inverter to be the frequency of the grid; or
decreasing the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and setting the set output frequency of the inverter to be the frequency of the grid.

10. A grid-connected control device based on a virtual synchronizer, wherein the grid-connected control device comprises:
a first deviation determination unit configured to detect whether a first deviation between an output voltage of an inverter and a voltage of a grid exceeds a first set voltage threshold;
a set output voltage adjustment unit configured to adjust a set output voltage of the inverter in a case that the first deviation exceeds the first set voltage threshold, so that the first deviation falls within the first set voltage threshold;
a second deviation determination unit configured to determine whether a second deviation between an output frequency of the inverter and a frequency of a grid exceeds a first set frequency threshold;
a set output frequency adjustment unit configured to adjust a set output frequency of the inverter in a case that the second deviation exceeds the first set frequency threshold, so that the second deviation falls within the first set frequency threshold; and
a control unit configured to control the inverter to connect to the grid when a phase of a voltage of the grid is consistent with a phase of an output voltage of the inverter in a case that the first deviation falls within the first set voltage threshold and the second deviation falls within the first set frequency threshold.

11. The grid-connected control device according to claim 10, wherein
the first deviation determination unit comprises:
a first deviation determination subunit configured to determine whether the output voltage of the inverter is greater than the voltage of the grid in a case that the first deviation between the output voltage of the inverter and the voltage of the grid exceeds the first set voltage threshold; and
the set output voltage adjustment unit comprises:
a set output voltage decrease adjustment subunit configured to decrease the set output voltage of the inverter with a preset first step size in a case that the output voltage of the inverter is greater than the voltage of the grid, and
a set output voltage increase adjustment subunit configured to increase the set output voltage of the inverter with a preset second step size in a case that the output voltage of the inverter is less than the voltage of the grid.

12. The grid-connected control device according to claim 10, wherein
the second deviation determination unit comprises:
a second deviation determination subunit configured to determine whether the output frequency of the inverter is greater than the frequency of the grid in a case that the second deviation between the output frequency of the inverter and the frequency of the grid exceeds the first set frequency threshold; and
the set output frequency adjustment unit comprises:
the set output frequency decrease adjustment subunit configured to decrease the set output frequency of the inverter with a preset third step size in a case that the output frequency of the inverter is greater than the frequency of the grid; and
the set output frequency increase adjustment subunit configured to increase the set output frequency of the inverter with a preset fourth step size in a case that the output frequency of the inverter is less than the frequency of the grid.

13. The grid-connected control device according to claim 10, further comprising:
a voltage recovery increase unit configured to increase the set output voltage of the inverter with a fifth step size after the inverter is connected to the grid successfully in a case that the set output voltage of the inverter is decreased with the preset first step size before the inverter is connected to the grid, until a third deviation between the set output voltage of the inverter and the voltage of the grid falls within a second set voltage threshold, and set the set output voltage of the inverter to be the voltage of the grid; and
a voltage recovery decrease unit configured to decrease the set output voltage of the inverter with a sixth step size after the inverter is connected to the grid successfully in a case that the set output voltage of the inverter is increased with the preset second step size before the inverter is connected to the grid, until a third deviation between the set output voltage of the inverter and the voltage of the grid falls within a second set voltage threshold, and set the set output voltage of the inverter to be the voltage of the grid.

14. The grid-connected control device according to claim 10, further comprising:
a frequency recovery increase unit configured to increase the set output frequency of the inverter with a seventh step size after the inverter is connected to the grid successfully in a case that the set output frequency of the inverter is decreased with the preset third step size before the inverter is connected to the grid, until a fourth deviation between the set output frequency of the inverter and the frequency of the grid falls within a second set frequency threshold, and set the set output frequency of the inverter to be the frequency of the grid; and
a frequency recovery decrease unit configured to decrease the set output frequency of the inverter with an eighth step size after the inverter is connected to the grid successfully in a case that the set output frequency of the inverter is increased with the preset fourth step size before the inverter is connected to the grid, until a fourth deviation between the set output frequency of the inverter and the frequency of the grid falls within a second set frequency threshold, and set the set output frequency of the inverter to be the frequency of the grid.
